(19) United States
(12) Patent Application Publication
(10) Pub. No.: US 2023/0262485 A1
(43) Pub. Date: Aug. 17, 2023

(54) Method and Apparatus to Control and Process a Plurality of Radar Sensors and Radio Units

(71) Applicants: Ramesh Annavajjala, Natick, MA (US); Kuntal Chowdhury, Andover, MA (US)

(72) Inventors: Ramesh Annavajjala, Natick, MA (US); Kuntal Chowdhury, Andover, MA (US)

(21) Appl. No.: 17/671,456

(22) Filed: Feb. 14, 2022

(51) Int. Cl. H04W 24/02; H04B 7/06; H04W 28/06; G01S 7/02

(52) U.S. Cl. CPC H04W 24/02; H04B 7/0617; H04W 28/06; G01S 7/02

(57) ABSTRACT

A plurality of radar sensors and radio units are controlled and processed by a signal processing unit (SPU). Each radar sensor receives configuration, control, power management, and calibration messages along with compressed data stream for transmission from the SPU over a multi Giga-bit interface (MGBI). Each radar sensor transmits status messages and compressed received data stream to the SPU over an MGBI. The SPU performs radar signal processing and tracking upon decompressing the data stream received from the radar sensor. Each radio unit receives configuration, control, power management, and calibration messages along with compressed frequency-domain waveform samples for each transmitter antenna port and for each component carrier configured by the SPU over an MGBI. Each radio unit transmits status messages along with compressed calibration data and compressed frequency-domain waveform samples for each receive antenna port and for each component carrier configured by the SPU over an MGBI. The SPU decompresses the frequency-domain waveform samples, and performs radio baseband signal processing including channel estimation, transmit beamforming, and receive beamforming. The SPU establishes and maintains time synchronization with each radar sensor and radio unit connected to it over an MGBI.

### DETAILED DESCRIPTION OF THE INVENTION

The embodiments of our invention provide methods for central control and processing of a plurality of radar sensors and radio units. Examples of radar sensors include FMCW based radar, active electronic steerable array (AESA) radar, pulse-Doppler radar, synthetic aperture radar (SAR), and distributed array radar (DAR). Examples of radio units include remote radio heads (RRHs) and massive multiple-input and multiple-output (massive-MIMO) radios.

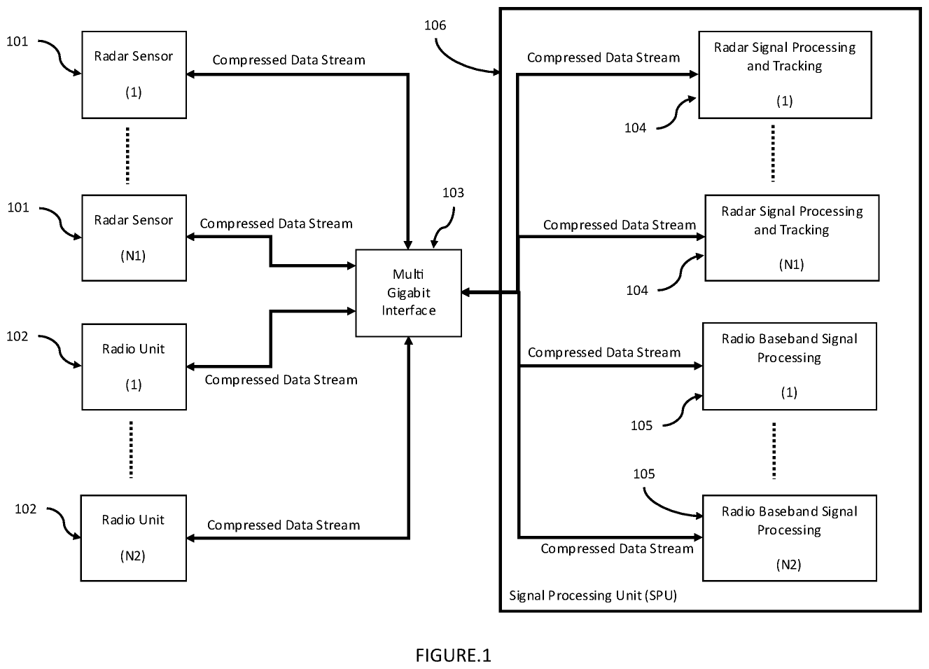

FIG. 1 shows an architecture of a centralized signal processing unit 106 controlling and processing multiple radar sensors 101 and multiple radio units 102 according to the embodiments of our invention. In this architecture, each radar sensor and each radio unit is interfaced with the SPU through a multi Giga-bit interface 103. Examples of multi Giga-bit interfaces are copper or optical based Ethernet interfaces, serial-and-deserializer (SerDes) interfaces, and camera serial interfaces (CSI) from mobile industry process interface (MIPI) alliance.

The signal processing unit 106 contains radar signal processing and tracking modules 104 to process the data received from the radar sensors, and radio baseband signal processing modules 105 to process the data received from the radio units. Modules 104 and 105 can be implemented in physical hardware such as GPUs, ASICs, DSPs, FPGAs, GPPs, tensor processing units, or can be virtualized to be processed on cloud infrastructure.

The multi Giga-bit interface 103 receives compressed data stream from each radar sensor 101 or radio unit 102 connected to the SPU, and sends that stream to an appropriate radar signal processing and tracking 104 or radio baseband signal processing 105 block.

Each radar sensor or radio unit requires optional time synchronization with the SPU, and it is to be understood that the SPU provides the required time synchronization signals over the multi Giga-bit interface. Examples of time synchronization algorithms are IEEE 1588 based precision time protocol, and GPS-disciplined time synchronization.

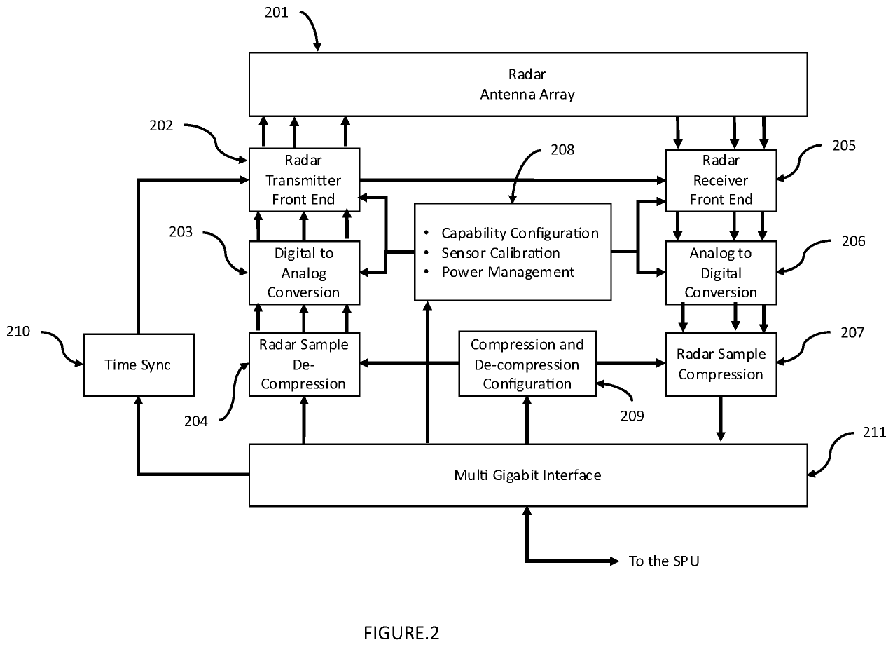

FIG. 2 shows the radar sensor blocks including the radar antenna array 201, radar transmitter front end 202, digital-to-analog conversion 203, radar sample de-compression 204, radar receiver front end 205, analog-to-digital conversion 206, radar sample compression 207, radar capability configuration 208, compression and de-compression configuration 209, time synchronization 210, and the multi Giga-bit interface 211 to the SPU according to the embodiments of our invention.

The radar sensor 101 is controlled by the SPU with commands received and parsed by the sensor through 211. Compressed data stream sent by the SPU is de-compressed in 204 based on the de-compression configuration received by 209 from the SPU. The de-compressed digital samples are sent to 203 to generate multiple analog data streams. Analog data streams drive 202 to produce radar transmit signals which are sent to the antenna array 201 for transmission over the air.

The radar transmitter front end is configured by the SPU through 208 to realize various functionalities such as carrier frequency configuration, waveform duration configuration, idle period configuration, waveform bandwidth configuration, calibration configuration, and power management configuration.

On the receive side of the radar sensor, radio frequency signals received from the antenna array 201 are sent to 205 for down conversion followed by analog-to-digital conversion by 206. The digital data streams from 206 are compressed by 207 based on the compression configuration 209 received from the SPU. The compressed data stream is packetized by 211 and is transmitted to the SPU.

Time synchronization signals are transmitted by the SPU over 210 to synchronize the radar sensor transmitter and receiver front ends 202 and 205, respectively.

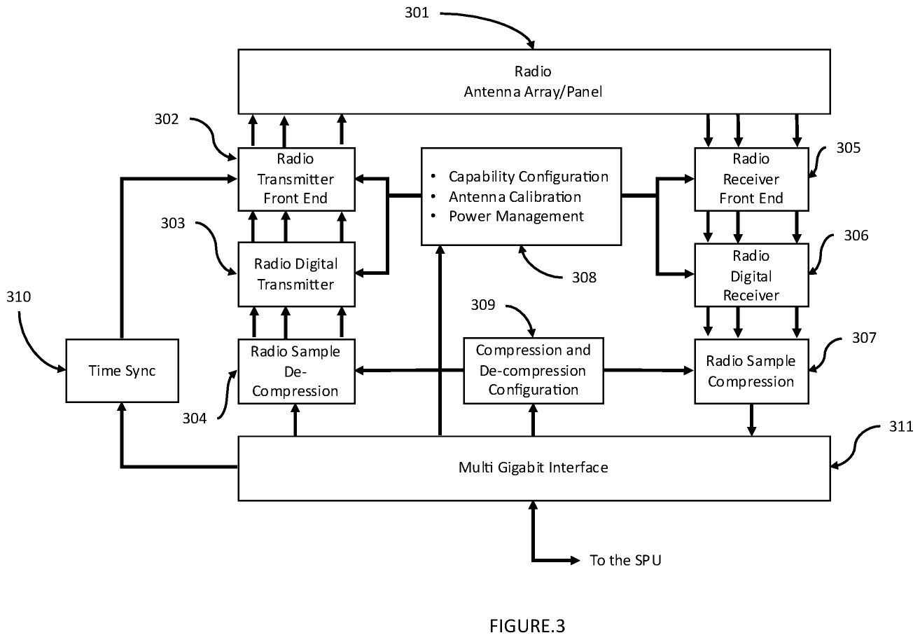

FIG. 3 shows radio unit sub-systems including the radio antenna array, also referred to as antenna panel, 301, radio transmitter front end 302, radio digital transmitter 303, radio sample de-compression 304, radio receiver front end 305, radio digital receiver 306, radio sample compression 307, radio capability configuration 308, compression and de-compression configuration 309, time synchronization 310, and a multi Giga-bit interface 311 to the SPU according to the embodiments of our invention.

The radio unit 102 is controlled by the SPU with commands received and parsed by the radio unit through 311. Compressed data streams for each transmit antenna port on each configured component carrier sent by the SPU are de-compressed in 304 based on the de-compression configuration received by 309 from the SPU. The de-compressed digital samples are sent to 303 to generate multiple analog data streams after aggregation over the component carriers. Analog data streams drive 302 to produce transmit signals over multiple antenna ports which are sent to the antenna array 301 for transmission over the air.

The radar transmitter front end is configured by the SPU through 308 to realize various functionalities such as carrier frequency configuration, waveform type configuration, waveform bandwidth configuration, antenna calibration configuration, and power management configuration. Examples of waveform types include 3GPP LTE and 3GPP NR (New Radio).

On the receive side of the radio unit, radio frequency signals received from the antenna array 301 are sent to 305 for down conversion followed by analog-to-digital conversion, component carrier extraction, and lower-physical-layer processing in 306. Per component carrier and per receive antenna port digital data stream from 306 is compressed by 307 based on the compression configuration 309 received from the SPU. The compressed data stream is packetized by 311 and is transmitted to the SPU.

Time synchronization signals are transmitted by the SPU over 310 to synchronize the radio transmitter and receiver front ends 302 and 303, respectively.

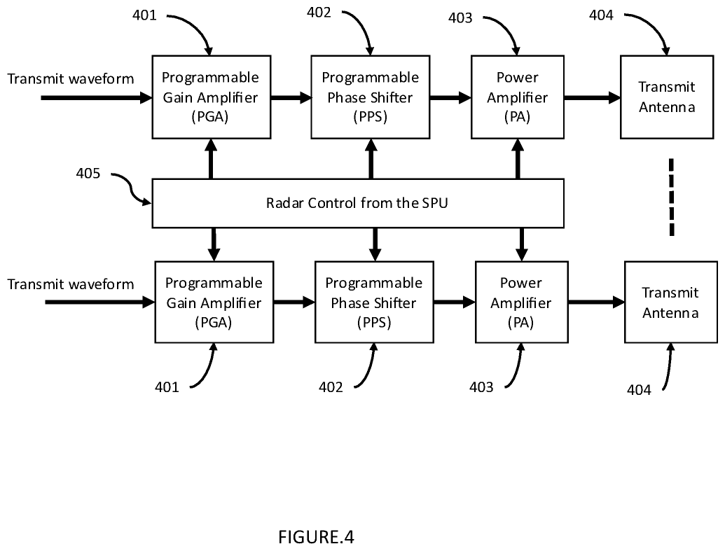

FIG. 4 shows the radar transmitter front end including programmable gain amplifier (PGA) 401, programmable phase shifter (PPS) 402, power amplifier 403, transmit antenna 404, and radar control 405 according to the embodiments of our invention.

Multiple transmit waveforms, one per transmit antenna path, are produced by 203. Each transmit waveform is sent to PGA 401 for gain adjustment and then to PPS 402 for phase adjustment followed by amplification by the PA 403 which is then sent to 404 for transmission over the air.

The gain of PGA 401, the phase of PPS 402, and the power amplifier 403 bias settings are controlled by the SPU through the radar control unit 405. The control signals from the SPU are received over the multi Giga-bit interface.

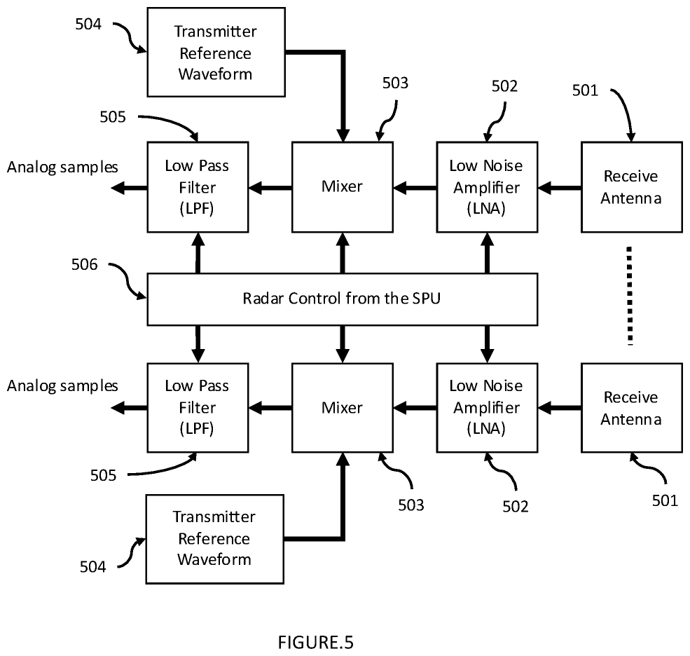

FIG. 5 shows the radar receiver front end including receive antenna 501, low noise amplifier (LNA) 502, mixer 503, transmit reference waveform 504, low pass filter (LPF) 505, and the radar control unit 506 according to the embodiments of our invention.

Radar sensor returns are received by each receive antenna 501 which are processed by the LNA 502 to reduce the noise and to improve the signal conditioning. The mixture 503 multiplies the signal received from the LNA 502 with a local transmitter reference waveform 504 to produce a down-converted signal. High-frequency components present in the down-converted signal are filtered out by the LPF 505 to produce analog-domain intermediate frequency signals. The LPF bandwidth, the mixture setting, and the LNA gain settings are controlled by the SPU via the radar control unit 506.

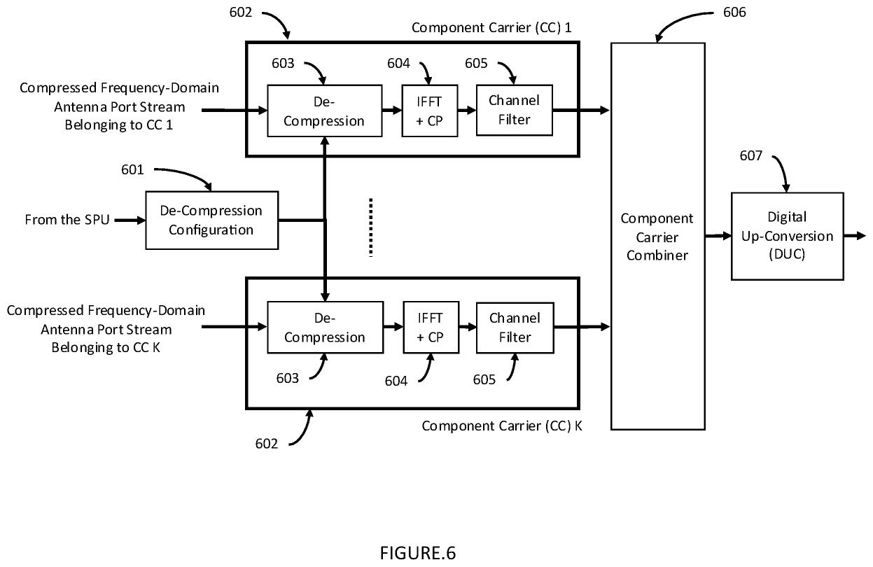

FIG. 6 shows the radio digital transmitter processing including de-compression configuration 601, component carrier processing 602, de-compression 603, inverse FFT (IFFT) and cyclic prefix (CP) addition 604, channel filter 605, component carrier combiner 606, and digital up-conversion (DUC) 607 according to the embodiments of our invention.

The SPU transmits compressed data stream for each component carrier to the radio unit. In FIG. 6, K such component carriers are shown. Each component carrier's compressed data is de-compressed by 603 with the de-compression settings received from the SPU on 601 to extract frequency-domain CC data. The frequency-domain CC data is sent to 604 to produce time-domain samples and to add cyclic prefix to the generated time-domain samples. CP-added time-domain stream of each component carrier is channel filtered by 605. After the per-component carrier channel filtering, each component carrier is added in 606 followed by digital up-conversion in 607.

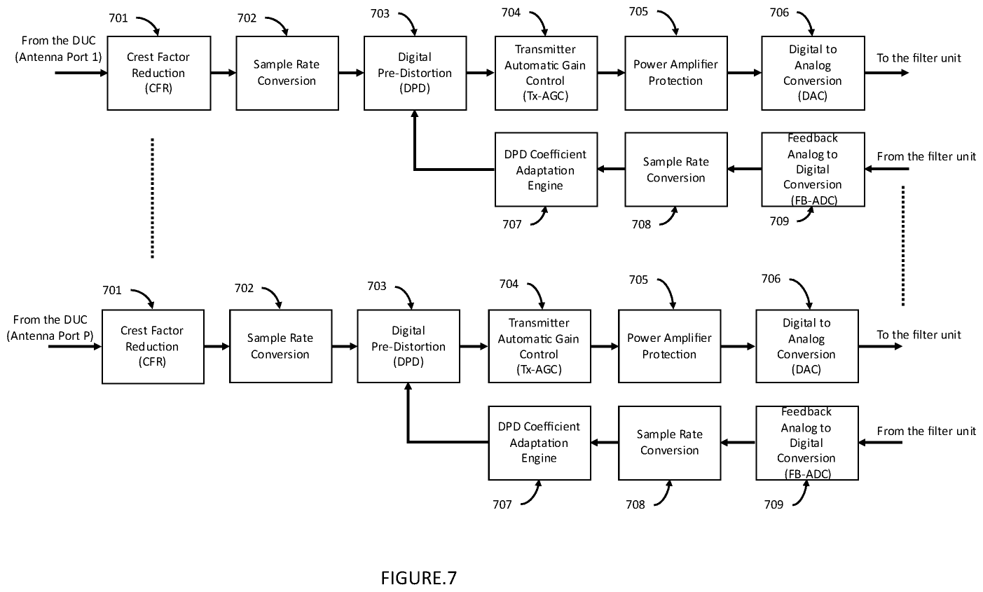

FIG. 7 shows the radio digital transmitter processing of multiple transmitter antenna ports including the crest factor reduction (CFR) 701, sample rate conversion 702, digital pre-distortion (DPD) 703, transmitter automatic gain control (Tx-AGC) 704, power amplifier protection 705, digital to analog conversion (DAC) 706, DPD coefficient adaptation engine 707, sample rate conversion 708, and feedback analog-to-digital conversion (FB-ADC) 709 according to the embodiments of our invention.

The up-converted digital sample stream for an antenna port is processed by 701 to reduce the peak-to-average power ratio (PAPR). The PAPR reduced stream is then sent to 702 for sample rate conversion which is then pre-distorted by 703 to make the resulting sample stream work with nonlinear transmit power amplifiers. The pre-distorted signal from 703 is sent to 704 for transmit gain control followed by digital power amplification with built-in PA protection 705 and then digital-to-analog conversion by 706. The output of the DAC is sent to the transmit filter unit for further processing.

The DPD in 703 is also termed as the forward path, or actuation path, or DPD filter. The DPD filter is typically a nonlinear transfer function with memory. The nonlinear transfer function and the DPD memory depth are programmable. The DPD filter coefficients are learned or adapted based on the samples received from the PA feedback path. The PA feedback consists of a receive filter unit followed by a feedback ADC 709 and sample rate conversion 708. The DPD adaptation engine 707 computes the DPD filter coefficients and loads them into 703 so that the forward path pre-distortion is computed based on the most recent power amplifier data.

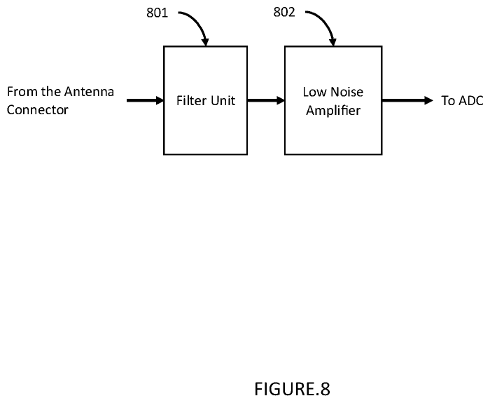

FIG. 8 shows the radio receiver analog front end including the filter unit 801 and the low noise amplifier 802 according to the embodiments of our invention. The received signal from the antenna connector is filtered by 801 which is transmission band specific. Examples of band-specific filters include a filter optimized to pass signals from 3.7 to 3.98 GHz frequency band covering 280 MHz of instantaneous bandwidth. The filtered analog received signal is further processed by 802 to reduce the noise and improve signal conditioning.

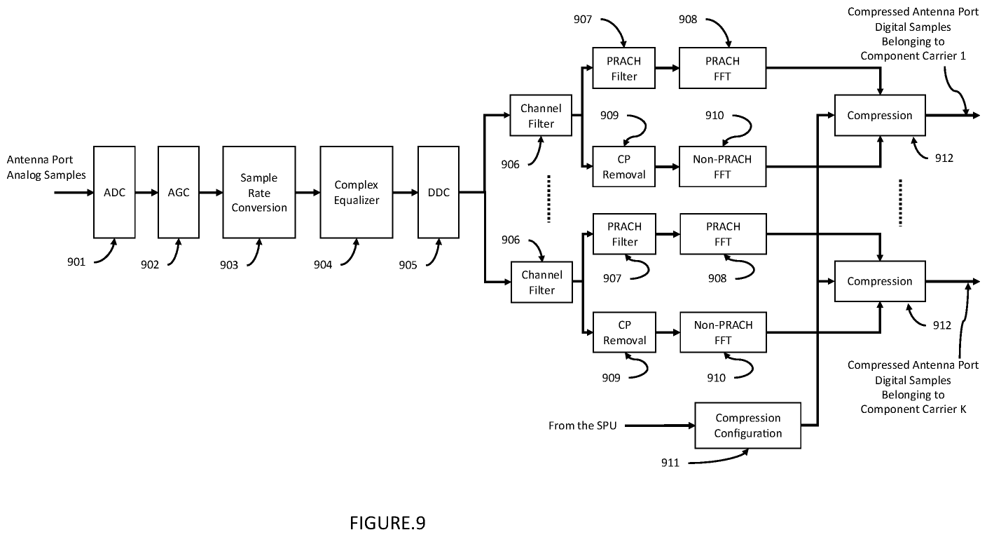

FIG. 9 shows radio digital receive processing to extract multiple component carriers' digital data streams including ADC 901, AGC 902, sample rate conversion 903, complex equalizer 904, digital down conversion (DDC) 905, channel filter 906, PRACH (physical random access channel) filter 907, PRACH FFT 908, CP removal 909, non-PRACH FFT 910, compression configuration 911, and compression 910 according to the embodiments of our invention.

The analog data stream on an antenna port is digitized by 901 followed by gain control by 902 and sample rate is adjusted by 903. Any gain or phase variations in the resulting digital stream are corrected by the complex equalizer 904. The resulting data stream is down converted by 905 and channel-specific filtering is done by 906 to extract per-component-carrier data streams.

The physical random access channel (PRACH) is a well-defined physical channel in 3GPP LTE and 3GPP NR cellular wireless standards. PRACH is configured over a set of frequency resources, also referred to subcarriers or tones or sub-channels, at specific time instances. PRACH is used to decode transmissions by unscheduled mobile terminals requesting for initial access, network re-entry, transmission opportunities, and handovers and hence PRACH is detected differently from non-PRACH channels such as uplink shared channels and uplink control channels.

When PRACH is configured, channel filtered component carrier at the output of 906 is PRACH filtered 907 followed by performing PRACH FFT 908 to extract the frequency-domain PRACH waveform samples. When PRACH is not configured, cyclic prefix is removed from the time-domain waveform in 909 followed by non-PRACH FFT in 910 to extract the frequency-domain samples of non-PRACH channels.

Frequency-domain samples of PRACH and non-PRACH channels are separately compressed by 912 based on the compression configuration 911 received from the SPU.

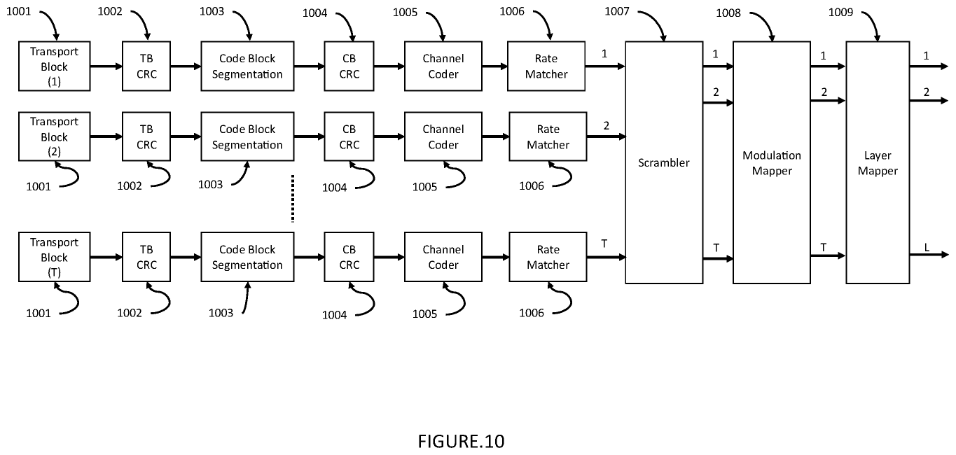

FIG. 10 shows the transport block (TB) processing flow of a given user including the TB generation 1001, cyclic redundancy check (CRC) insertion 1002, code block segmentation 1003, CB CRC insertion 1004, channel coding 1005, rate matching 1006, scrambling 1007, modulation mapping 1008, and layer mapping 1009 according to the embodiments of our invention.

A given user is configured to receive multiple transport blocks 1001 over a set of space, time and frequency resources. A CRC check 1002 is computed on each transport block received from higher layers and is appended to that transport block. CRC appended transport blocks are segmented 1003 based on the code block size and CRC is computed 1004 on each code block segment. Each CRC appended code block is sent to a channel coder 1005 to produce error correction coded codewords which are rate matched 1006 to fit into the configured space, time, and frequency resources. Examples of channel coders include low-density parity check (LDPC) codes, Turbo codes, convolutional codes, and Polar codes. The rate matched coded bits from each transport block are aggregated, scrambled 1007, and modulation mapped 1008 to produce as many modulation symbol streams as the number of transport blocks. The modulation symbol streams are sent to the layer mapper 1009 to produce multiple layer mapped symbol streams. An example mapping of modulation symbol stream and layer mapped symbol stream is as follows: With 1 modulation symbol stream s[1],s[2],s[3], . . . , and two layer mapped symbol streams u[1],u[2],u[3], . . . , and v[1],v[2],v[3], . . . , we have u[1]=s[1], v[1]=s[2], u[2]=s[3], v[2]=s[4], . . . , and u[k]=s[2*k-1] and v[k]=s[2*k].

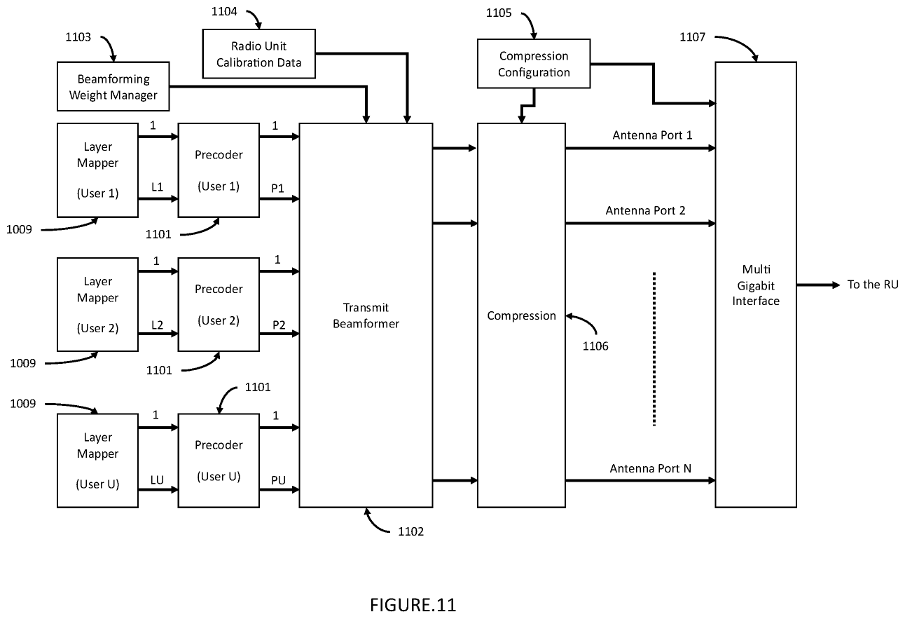

FIG. 11 shows the multi-user transmit beamforming processing on the SPU including precoding of each user's layer mapped data stream 1101, transmit beamformer 1102, beamforming weight manager 1103, radio unit calibration data 1104, frequency-domain compression configuration 1105, frequency-domain data compression 1106, and multi Giga-bit interface 1107 according to the embodiments of our invention.

Each user's layer mapped modulation symbol stream 1009 is individually precoded by 1101. The precoder operation maps an L-dimensional input vector into a P-dimensional output vector, and this operation can be linear or nonlinear. Examples of nonlinear precoders include Tomlinson-Harashima precoder and dirty-paper precoder. For a linear precoder, the mapping operation is a matrix-vector operation with the matrix is of size P-by-L and the vector is of size L-by-1 yielding a P-by-1 vector at the output of the precoder.

The precoded symbol streams from all the users assigned over a set of space, time, and frequency resources are beamformed by 1102. The beamformer operation maps a P-dimensional input vector into an N-dimensional output vector, and this operation can be linear or nonlinear. The input dimension P is the total number of precoded symbols, P=P1+P2+ . . . +PU, where U is the number of users, and the output dimension N is the number of antenna ports. For a linear transmit beamformer, the beamformer matrix W is of size N-by-P. The beamformer weight W is managed by 1103. The beamformer module 1102 also makes use of the calibration data received from the radio unit 1104 to refine the weights received from 1103.

The output the transmit beamformer is an N-dimensional frequency-domain symbol stream with N being the number of configured antenna ports. For a 64-transmit and 64-receive massive MIMO radio unit, N is equal to 64. Frequency-domain symbol streams of all the antenna ports are sent to the compression unit 1106. Based on the compression configuration parameters 1105, each antenna port data is individually compressed or all the antenna port data is jointly compressed. Example compression algorithms include differential pulse code modulation, delta modulation and vector quantization. The compressed data streams from all the antenna ports are sent to the radio unit over the multi Giga-bit interface 1107.

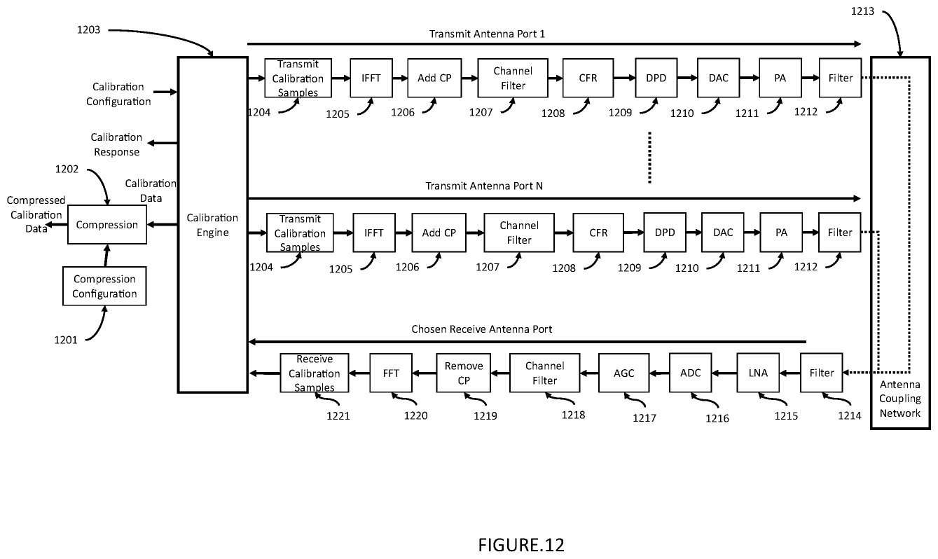

FIG. 12 shows receiver antenna port calibration on the radio unit including the compression configuration from the SPU 1201, compression of the calibration data 1202, calibration engine 1203, transmit calibration sample generation 1204, inverse FFT operation 1205, cyclic prefix addition operation 1206, channel filtering operation 1207, crest factor reduction 1208, digital pre-distortion 1209, digital to analog conversion 1210, transmit power amplifier 1211, transmit filter 1212, antenna coupling network 1213, receive filter 1214, low-noise amplifier 1215, analog-to-digital conversion 1216, automatic gain control 1217, receive channel filter 1218, cyclic prefix removal operation 1219, FFT operation 1220, and receive calibration sample extraction 1221 according to the embodiments of our invention.

Radio units require careful calibration of transmit and receive paths to account for variations in antenna line lengths, gain and phase variations as a function of time, frequency, and temperature. Calibration commands from the SPU include, but not limited to, calibration frequency (i.e., number of calibrations per sec), transmit versus receive calibration, antenna port to be calibrated, the duration of each calibration period, the carrier frequency range over which calibration may be performed, and the power level used for calibration.

Upon receiving calibration commands from the SPU, 1203 prepares the transmit waveforms on each transmit antenna port. Frequency-domain calibration waveform samples 1204 are as orthogonal as possible across each transmit antenna port. These waveform are converted into time-domain samples 1205 and then cyclic-prefix 1206 is added prior to performing channel filtering 1207. Crest factor reduction 1208 is applied on the channel filtered samples to reduce the PAPR and then pre-distorted 1209 prior to sending to a DAC 1210 to generate analog time-domain waveform. The analog waveform is used to drive the PA 1211 and then channel filtered 1212.

The antenna coupling network 1213 is responsible to connect one or multiple transmit antenna ports to one or multiple receive antenna ports. All the transmit antenna ports are activated to perform receive antenna port calibration. The aggregate transmit analog waveform from multiple transmit antenna ports is filtered out by receive analog filter 1214 which is then signal conditioned 1215, digitized 1216, gain controlled 1217, channel filtered 1218, cyclic prefix removed 1219, and converted to frequency-domain samples by 1220. Calibration samples on the configured receive antenna port 1221 are compressed 1202 and transmitted to the SPU over an MGBI.

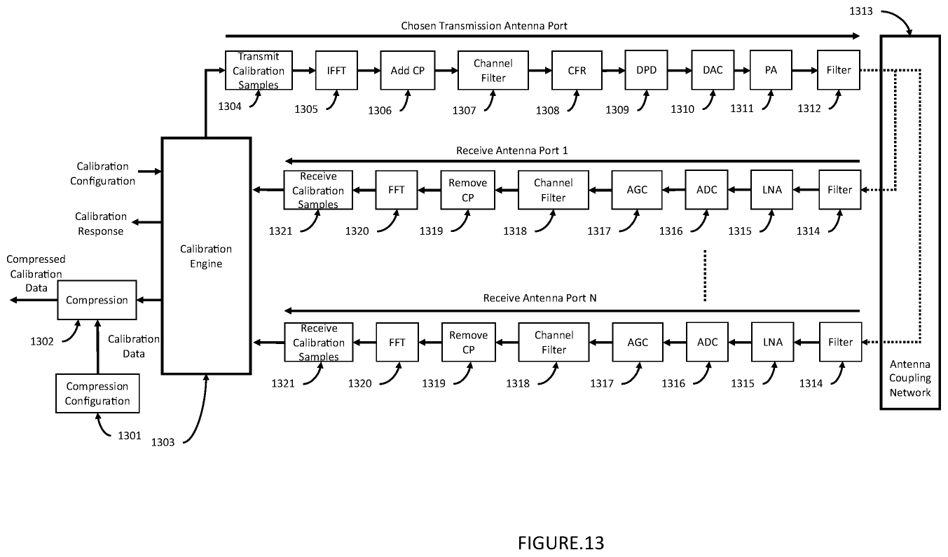

FIG. 13 shows transmit antenna port calibration on the radio unit including compression configuration from the SPU 1301, compression of the calibrated data 1302, calibration engine 1303, transmit calibration samples 1304, inverse FFT 1305, cyclic prefix addition operation 1306, channel filtering operation 1307, crest factor reduction 1308, digital pre-distortion 1309, digital to analog conversion 1310, transmit power amplifier 1311, transmit filter 1312, antenna coupling network 1313, receive filter 1314, low-noise amplifier 1315, analog-to-digital conversion 1316, automatic gain control 1317, receive channel filter 1318, cyclic prefix removal operation 1319, FFT operation 1320, and receive calibration sample extraction 1321 according to the embodiments of our invention.

Unlike in the receive calibration process wherein all the transmit antenna ports are active for a configured receive antenna port to be calibrated, in transmit antenna calibration process all the receive ports are in use while only a selected transmit antenna port is configured. The antenna coupling network 1313 couples the signal from the configured transmit antenna port to each receive antenna port. Calibration samples on each receive antenna port 1321 are compressed 1302 and transmitted to the SPU over an MGBI.

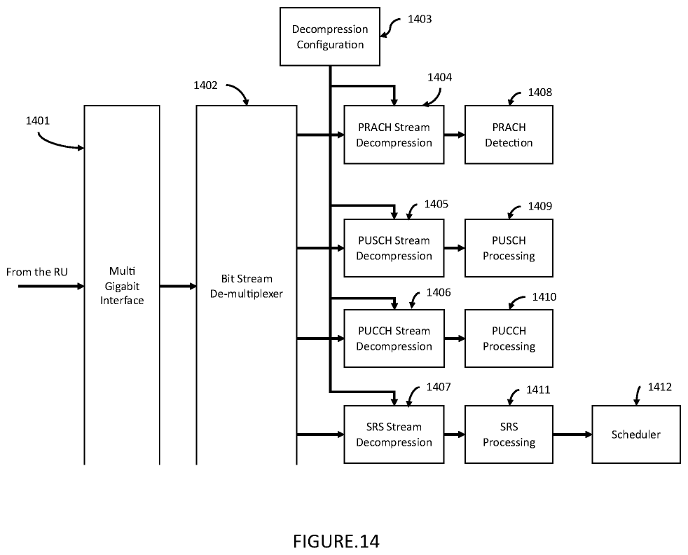

FIG. 14 shows extraction and processing of physical layer channels at the SPU when the sounding reference symbol (SRS) is configured including MGBI 1401, bit stream de-multiplexer 1402, de-compression configuration 1403, PRACH stream de-compression 1404, physical uplink shared channel (PUSCH) stream de-compression 1405, physical uplink control channel (PUCCH) stream de-compression 1406, SRS stream de-compression 1407, PRACH detection 1408, PUSCH processing 1409, PUCCH processing 1410, SRS processing 1411, and upper layer scheduler 1412 according to the embodiments of our invention.

Upon receiving the compressed frequency-domain samples from the radio unit over 1401, the SPU de-multiplexes the bit streams into PRACH 1404, PUSCH 1405, PUCCH 1406, and SRS 1407 channels. Each of these channels contain compressed bit streams from one or more component carriers on all the receive antenna ports. With per-component-carrier de-compression configuration 1403 each channel bit stream is individually de-compressed. The PRACH channel is processed in 1408 to detect the PRACH preamble indices and to estimate the timing offset of each PRACH user. PUSCH and PUCCH physical channels contains demodulation reference signals (DMRS). PUSCH processing 1409 includes single-user or multi-user MIMO channel estimation, single-user or multi-user MIMO equalization, and channel decoding to extract the transport blocks. PUCCH processing 1410 includes single-user or multi-user MIMO channel estimation, single-user or multi-user MIMO equalization, and control channel decoding to extract the channel quality information, rank information, precoder matrix information, and transport block decoding status. The SRS processing 1411 involves extraction of transmitted frequency combs, and performing SRS based channel estimation. The SRS channel estimates are sent to the scheduler 1412 to perform user pairing, frequency-domain scheduling decisions, interference management, and MIMO transmit precoder weight generation.

We note that in “0-RAN Fronthaul Working Group Control, User and Synchronization Plane Specification, O-RAN.WG4.CUS.0-v07.00 Technical Specification,” precoding and beamforming functionality is contained in the massive MIMO radio units. According to the embodiments of our invention, precoding and beamforming functionality is moved to the SPU.

We note that in “0-RAN Fronthaul Working Group Control, User and Synchronization Plane Specification, O-RAN.WG4.CUS.0-v07.00 Technical Specification,” sounding reference symbol is processed on the massive MIMO radio units. According to the embodiments of our invention, sounding reference symbol extraction functionality is moved to the SPU.

We note that in “5G FAPI: PHY API Specification, Document 222.10.04. Small Cell Forum. November 2021,” channel estimation, equalization, and channel decoding are contained in the radio unit for Option 6 split. According to the embodiments of our invention, channel estimation, equalization, and channel decoding functionalities are performed at the SPU.

We note that in “ORAN-WG4: Improved 7-2× UL Performance for mMIMO. Dec. 14, 2021,” PUSCH processing including DMRS extraction, PUSCH channel estimation, beamformer weight calculations, and MIMO equalization are contained in the radio unit. According to the embodiments of our invention, PUSCH processing is performed at the SPU.

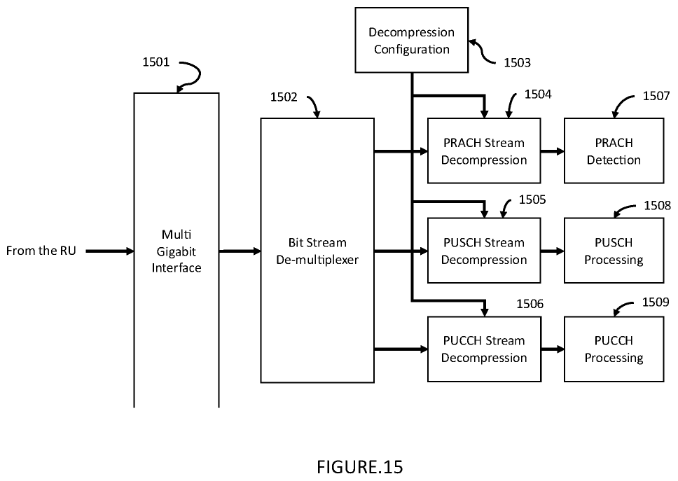

FIG. 15 shows extraction and processing of physical layer channels at the SPU when the SRS is not configured including multi Giga-bit interface 1501, bit stream de-multiplexer 1502, de-compression configuration 1503, PRACH stream de-compression 1504, PUSCH stream de-compression 1505, PUCCH stream de-compression 1506, PRACH detection 1507, PUSCH processing 1508, and PUCCH processing 1509 according to the embodiments of our invention.

SRS is not configured in many scenarios such as high-mobility operating conditions in a time-division duplex (TDD) based radio network and bandwidth limited frequency-domain duplex (FDD) based radio networks. Physical channel processing of PRACH 1504 and 1507, PUSCH 1505 and 1508, and PUCCH 1506 and 1509 remains unchanged at the SPU irrespective or the presence of SRS.

1. A method for processing a plurality of radar sensors where radar signal processing functionality is split between the radar sensor and the SPU.

2. The method of claim 1, wherein the radar sensor transmits compressed data stream to the SPU.

3. The method of claim 1, wherein the radar sensor receives compressed data stream from the SPU.

4. The method of claim 1, wherein the radar sensor capability is configured by the SPU.

5. The method of claim 1, wherein the radar sensor capability information is retrieved by the SPU.

6. The method of claim 1, wherein the SPU establishes the time synchronization with the radar sensor.

7. A method for processing a plurality of radio units where radio signal processing functionality is split between the radio unit and the SPU.

8. The method of claim 7, wherein digital transmit beamforming functionality resides in the SPU.

9. The method of claim 7, wherein digital receive beamforming functionality resides in the SPU.

10. The method of claim 7, wherein sounding reference symbol extraction functionality resides in the SPU.

11. The method of claim 7, wherein the radio unit transmits compressed digital antenna port samples to the SPU.

12. The method of claim 7, wherein the radio unit receives compressed digital antenna port samples from the SPU.

13. The method of claim 7, wherein the radio unit capability is configured by the SPU.

14. The method of claim 7, wherein the radio unit capability information is retrieved by the SPU.

15. The method of claim 7, wherein the radio unit calibration is configured by the SPU.

16. The method of claim 7, wherein the radio unit transmits compressed calibration data to the SPU.

17. The method of claim 7, wherein the SPU establishes the time synchronization with the radio unit.

18. The method of claim 7, wherein the SPU adjusts the transmit beamforming weights based on the calibration data received from the radio unit.

19. The method of claim 7, wherein the SPU adjusts the receive beamforming weights based on the calibration data received from the radio unit.
